(19) United States
(12) Patent Application Publication
(10) Pub. No.: US 2025/0264390 A1
(43) Pub. Date: Aug. 21, 2025

(54) APPARATUS AND METHOD FOR MEASURING ELASTIC MODULUS

(71) Applicants: HYUNDAI MOBIS CO., LTD., Seoul (KR); Research & Business Foundation SUNGKYUNKWAN UNIVERSITY, Suwon-si (KR)

(72) Inventors: Eun Ho Lee, Suwon-si (KR); Ji Hyun Park, Seoul (KR); Dong Wook Yang, Seoul (KR); Young Dae Shim, Suwon-si, Gyeonggi-do (KR); Ji Hun Kim, Suwon-si (KR)

(73) Assignees: HYUNDAI MOBIS CO., LTD., Seoul (KR); Research & Business Foundation SUNGKYUNKWAN UNIVERSITY, Suwon-si (KR)

(21) Appl. No.: 18/936,577

(22) Filed: Nov. 4, 2024

(30) Foreign Application Priority Data
Feb. 21, 2024 (KR) 10-2024-0025288

(51) Int. Cl. G01N 3/20

(52) U.S. Cl. CPC G01N 3/20; G01N 2203/0023; G01N 2203/0075

(57) ABSTRACT

The present disclosure relates to an apparatus and method for measuring an elastic modulus. The method of measuring an elastic modulus of a specimen including a conductive material and an insulating material with which a surface of the conductive material is coated includes a first bending test operation of applying a first load to a first surface of the specimen, a second bending test operation of applying a second load to a second surface that meets the first surface of the specimen, a first calculation operation of calculating a first bending elastic modulus of the specimen based on a first value measured in the first bending test operation, a second calculation operation of calculating a second bending elastic modulus of the specimen based on a second value measured in the second bending test operation, and a third calculation operation of calculating an elastic modulus of the conductive material and an elastic modulus of the insulating material based on the calculated first bending elastic modulus and the calculated second bending elastic modulus.

Pursuant to 35 U.S.C. § 119 (a), this application claims the benefit of earlier filing dates and right of priority to Korean Application No. 10-2024-0025288, filed on Feb. 21, 2024, the contents of which are hereby incorporated by reference herein in their entirety.

### BACKGROUND OF THE DISCLOSURE

### Field of the Disclosure

Embodiments relate to an apparatus and method for measuring an elastic modulus, and more particularly, to an apparatus and method for measuring an elastic modulus of each material constituting a composite material through a bending test of the composite material.

### Discussion of the Related Art

There are two types of tests for measuring an elastic modulus including a bending test and a tensile test.

The bending test is a test used to measure a degree at which a material is to be bent, especially, a test used to measure the characteristics in a long specimen, that is, a test for measuring a degree at which a material is bent by applying a load. The tensile test is a test for evaluating the strength and elasticity of a material by measuring a degree at which the material is capable of withstanding tension (resistance to a force that stretches or expands), that is, a test of measuring an amount of elongation while applying a tensile force in opposite directions from both ends.

However, conventional tensile tests have the problem that it is difficult to manufacture specimens for tensile tests in the form of wires. Even when the specimens are manufactured, there is a problem in that it is difficult to cause uniform deformation within the material that makes up the specimen.

Conventional bending tests have a problem in that it is possible to measure only a bending elastic modulus of a composite material itself and it is not possible to measure respective elastic moduli of materials constituting the composite material.

### SUMMARY OF THE DISCLOSURE

To resolve the above problems, embodiments provide an apparatus/method for measuring an elastic modulus of each material constituting a composite material.

Embodiments provide an apparatus/method for measuring not only a tensile elastic modulus but also a bending elastic modulus through a bending test.

It will be appreciated by one of ordinary skill in the art that the objects that could be achieved with the present disclosure are not limited to what has been particularly described hereinabove and the above and other objects that the present disclosure could achieve will be more clearly understood from the following detailed description.

According to embodiments of the present disclosure, a method of measuring an elastic modulus of a specimen including a conductive material and an insulating material with which a surface of the conductive material is coated includes a first bending test operation of applying a first load to a first surface of the specimen, a second bending test operation of applying a second load to a second surface that meets the first surface of the specimen, a first calculation operation of calculating a first bending elastic modulus of the specimen based on a first value measured in the first bending test operation, a second calculation operation of calculating a second bending elastic modulus of the specimen based on a second value measured in the second bending test operation, and a third calculation operation of calculating an elastic modulus of the conductive material and an elastic modulus of the insulating material based on the calculated first bending elastic modulus and the calculated second bending elastic modulus.

According to embodiments, the first bending test operation and the second bending test operation may be performed in an elastic region of the specimen.

According to embodiments, the first bending test operation and the second bending test operation may be performed through a four-point bending test with two application points in which the first load is applied to the first surface and two application points in which the second load is applied to the second surface.

According to embodiments, a cross section of the specimen may be rectangular, and the first calculation operation and the second calculation operation may include calculating the first bending elastic modulus and the second bending elastic modulus based on a following equation, respectively,

$${E}_{B} = 0.21 \frac{{PL}^{3}}{{δ}_{c} {bd}^{3}} \qquad Equation$$

where E_{B} is the first bending elastic modulus or the second bending elastic modulus, P is the first load or the second load, L is a length between supports supporting both lower portions or lateral portions of the specimen, δ_{c} is a measured center displacement of the specimen, b is a width of the specimen, and d is a height of the specimen.

According to embodiments, the third calculation operation includes calculating a bending elastic modulus of the conductive material and an elastic modulus of the insulating material based on a following equation,

$${E}_{T} A = {E}_{C} {A}_{C} + {E}_{E} {A}_{E} \qquad Equation$$

where E_{C} is an elastic modulus of the conductive material, E_{E} is an elastic modulus of the insulating material, E_{B,1} is the first bending elastic modulus, E_{B,2} is the second bending elastic modulus, I₁ is a geometrical moment of inertia of the specimen in the first bending test operation, I₂ is a geometrical moment of inertia of the specimen in the second bending test operation, I_{C,1} is a geometrical moment of inertia of the conductive material in the first bending test operation, I_{C,2} is a geometrical moment of inertia of the conductive material in the second bending test operation, I_{E,1} is a geometrical moment of inertia of the insulating material in the first bending test operation, and I_{E,2} is a geometrical moment of inertia of the insulating material in the second bending test operation.

According to embodiments, the method may further include a fourth calculation operation of calculating a tensile elastic modulus of the specimen based on a calculated elastic modulus of the conductive material and a calculated elastic modulus of the insulating material.

According to embodiments, the fourth calculation operation includes calculating a tensile elastic modulus of the specimen based on a following equation,

$${E}_{T} A = {E}_{C} {A}_{C} + {E}_{E} {A}_{E} \qquad Equation$$

where E_{T} is the tensile elastic modulus, E_{C} is an elastic modulus of the conductive material, E_{E} is an elastic modulus of the insulating material, A is a cross section of the specimen, A_{C} is a cross section of the conductive material, and A_{E} is a cross section of the insulating material.

According to embodiments, the first bending test operation and the second bending test operation include applying the first load and the second load to the specimen at a specific speed, respectively, wherein the specific speed satisfies a following equation,

$$V = 0.185 \frac{\dot{ε} {L}^{2}}{d} \qquad Equation$$

where V is a speed at which the first load or the second load is applied, \dot{ε} is a speed of a strain at a lowest portion of the specimen, L is a length between supports supporting both portions or lateral portions of the specimen, and d is a height of the specimen.

According to embodiments of the present disclosure, an apparatus for measuring an elastic modulus includes a pair of supports supporting at least one of a lower surface of two ends of a specimen or a lateral portion of the two ends, a pressurizer configured to apply a load to an upper surface of the specimen, and a sensor configured to measure a displacement by which the specimen is deformed by the load, wherein the specimen includes a conductive material, and an insulating material with which a surface of the conductive material is coated, and the apparatus includes a four-point bending test apparatus with two application points in which the road is applied to an upper surface of the specimen.

According to embodiments, the pressurizer applies the load to the upper surface of the specimen at a specific speed, and the specific speed satisfies a following equation,

$$V = 0.185 \frac{\dot{ε} {L}^{2}}{d} \qquad Equation$$

where V is a speed at which the load is applied, \dot{ε} is a speed of a strain at a lowest portion of the specimen, L is a length between the pair of supports, and d is a height of the specimen.

### BRIEF DESCRIPTION OF THE DRAWINGS

FIG. 1 is a front view illustrating an elastic modulus measuring apparatus according to embodiments;

FIG. 2 is a diagram illustrating an example of a pair of supports of an elastic modulus measuring apparatus according to embodiments;

FIG. 3 is a diagram illustrating an example of a specimen as a measurement target of an elastic modulus measuring method and apparatus according to embodiments;

FIG. 4 is a flowchart illustrating a method for measuring an elastic modulus according to embodiments;

FIG. 5 is a flowchart illustrating a method for measuring an elastic modulus according to embodiments;

FIG. 6 is a diagram to explain a method for measuring a bending elastic modulus of an elastic modulus measuring method and apparatus according to embodiments;

FIG. 7 is a diagram to explain a speed of a load applied to a specimen of a method and apparatus for measuring elastic modulus according to embodiments; and

FIG. 8 is a table showing values of a bending elastic modulus and a tensile elastic modulus calculated by a method and apparatus for measuring an elastic modulus according to the embodiments.

### DETAILED DESCRIPTION OF THE DISCLOSURE

Hereinafter, the present disclosure will be described in detail by explaining exemplary embodiments of the present disclosure with reference to the attached drawings. The same reference numerals in the drawings denote like elements, and a repeated explanation thereof will not be given.

The suffixes “module” and “unit” of elements herein are used for convenience of description and thus can be used interchangeably and do not have any distinguishable meanings or functions. In the following description of the present disclosure, a detailed description of known functions and configurations incorporated herein will be omitted when it may make the subject matter of the present disclosure unclear.

The features of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms first, second, third etc. may be used herein to describe various elements, these elements should not be limited by these terms. These terms are only used to distinguish one element from another element.

It will be understood that when an element is referred to as being “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present.

The singular expressions in the present specification include the plural expressions unless clearly specified otherwise in context.

It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

Embodiments relate to standard KS C 3006, which prescribes test methods for enameled copper wire and enameled aluminum wire. Embodiments relate to an apparatus and method for measuring elastic moduli of copper and enamel constituting an enamel wire (enamel copper wire), respectively.

The current standard KS C 3006 only specifies the measurement of elongation of enamel wire, and does not specify the measurement of an elastic modulus of enamel wire. Accordingly, embodiments describe an apparatus/method for measuring the elastic modulus of an enamel wire efficiently and stably, as well as for measuring the elastic modulus of each material making up the enamel wire. Due to this, embodiments have an effect of measuring not only the elastic modulus of the enamel wire but also the elastic modulus of each material making up the enamel wire.

An apparatus and method for measuring an elastic modulus according to embodiments will be described in detail with reference to the attached drawings, and repeated descriptions will be omitted.

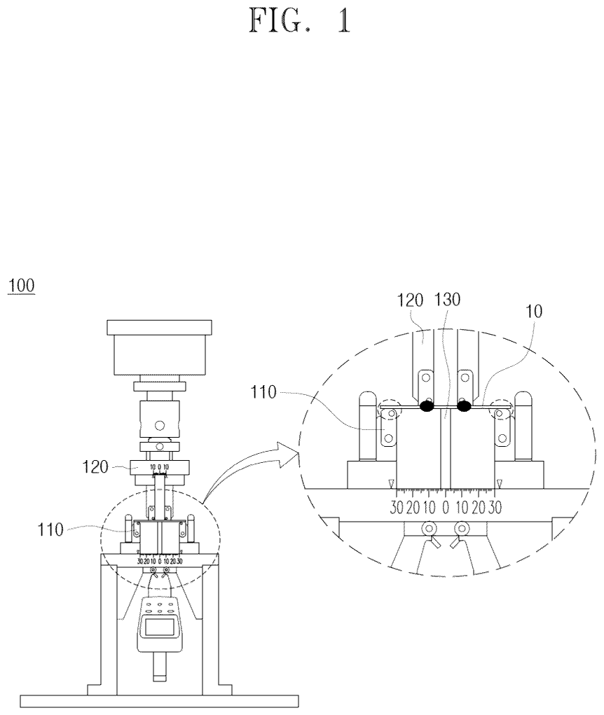

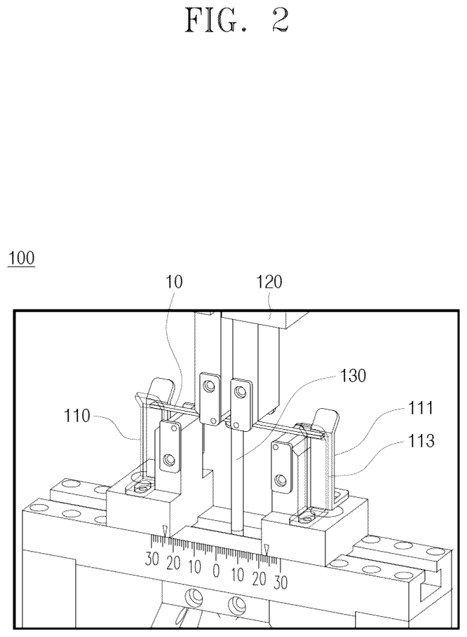

FIG. 1 is a front view illustrating an elastic modulus measuring apparatus according to embodiments. FIG. 2 is a diagram illustrating an example of a pair of supports of an elastic modulus measuring apparatus according to embodiments.

An elastic modulus measuring apparatus 100 illustrated in FIG. 2 may correspond to an elastic modulus measuring apparatus 100 illustrated in FIG. 1.

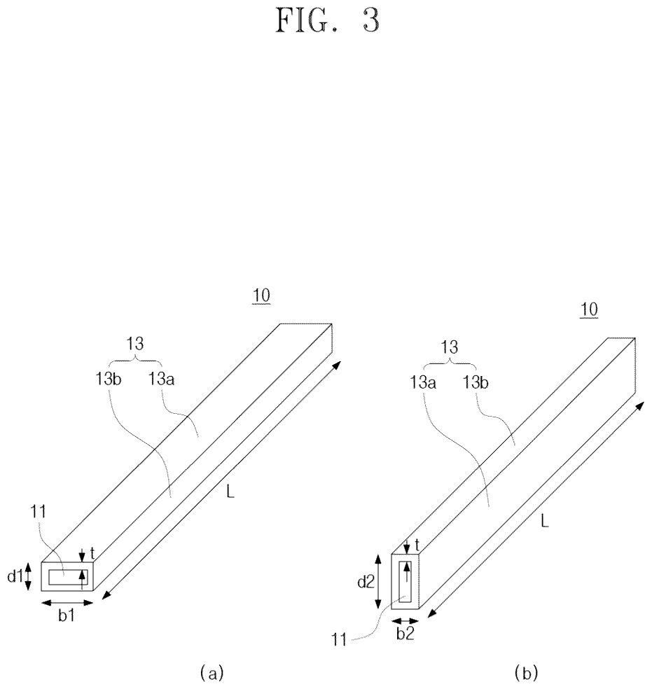

Referring to FIGS. 1 and 2, the elastic modulus measuring apparatus 100 may be an apparatus for measuring a specimen 10 and may include a support 110, a pressurizer 120, and a sensor 130. A detailed description of the specimen 10 is given with reference to FIG. 3.

The support 110 may support or fix a lower or lateral portion of the specimen 10 and may be configured as a pair of supports to support both ends. The support 110 may support both ends of a lower surface of the specimen 10 as shown in FIG. 1 or may support one side and the other side of the specimen 10 as shown in FIG. 2.

In more detail, as shown in FIG. 2, the support 110 that supports one side and the other side of the specimen 10 may include a first support member 111 and a second support member 113 that are spaced apart from each other by a certain distance. In this case, the certain distance may be adjusted to correspond to a horizontal length of the specimen 10. That is, a distance between the first support member 111 and the second support member 113 may be adjusted to correspond to the horizontal length (or width length) of the specimen 10 such that the support 110 may support the lateral portion of the specimen 10.

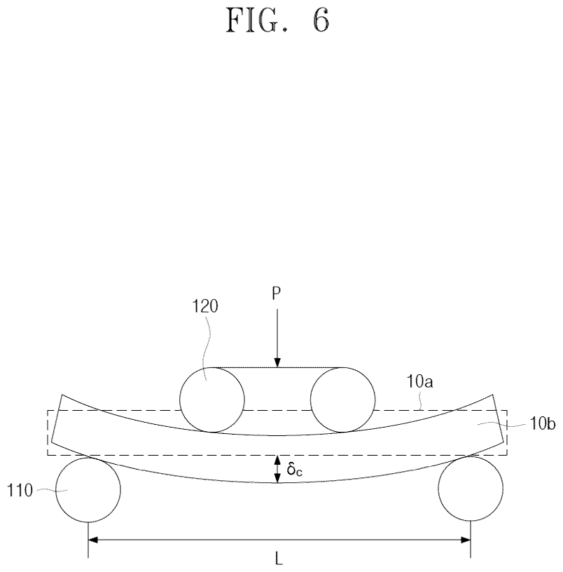

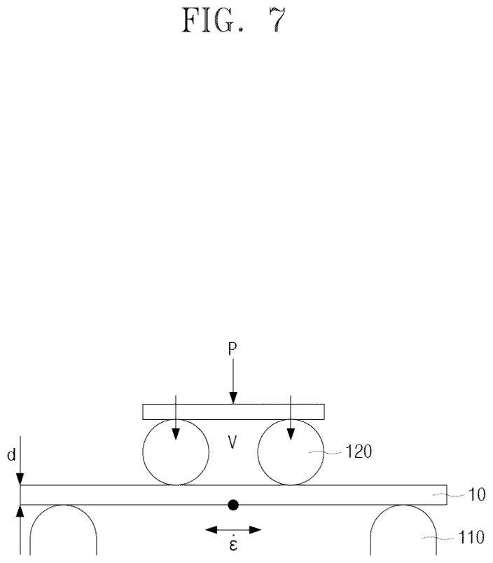

The pressurizer 120 may apply a load P (refer to FIGS. 6 and 7) to an upper surface of the specimen 10. That is, the elastic modulus measuring apparatus 100 according to embodiments may be a type of bending test apparatus that measures an elastic modulus of the specimen 10 by measuring the amount of deflection 8 (refer to FIG. 6) of the specimen 10, which occurs by applying a load to the upper surface of the specimen 10.

A bending test is an experiment that places a specimen at two points a certain distance apart and applies a load perpendicular to the specimen at a constant speed until the specimen is destroyed, thereby measuring stress and distortion. In this case, the pressurizer 120 of the elastic modulus measuring apparatus 100 according to embodiments may apply a load within a range in which the specimen 10 is not permanently deformed due to the load. In other words, the pressurizer 120 of the elastic modulus measuring apparatus 100 according to embodiments may apply a load such that a deformation range of the specimen 10 falls within an elastic region.

In more detail, the elastic modulus measuring apparatus 100 according to embodiments may include a four-point bending test apparatus with two application points in which a load is applied to the upper surface of the specimen 10. That is, as illustrated in FIG. 1, the pressurizer 120 may apply a load to the upper surface of the specimen 10, and in this case, the number of application points in which a load is applied may be two points spaced apart from each other rather than one. For example, when the load applied by the pressurizer 120 to the specimen 10 is P, the load P may be distributed and applied to two points on the specimen 10 rather than being applied to one point on the specimen 10.

The amount of deflection 8, of the specimen 10 caused by the pressurizer 120 may be measured by the sensor 130. That is, the sensor 130 may measure a displacement 8, by which the specimen 10 is deformed by the load. A detailed description thereof is given with reference to FIG. 6.

FIG. 3 is a diagram illustrating an example of a specimen as a measurement target of an elastic modulus measuring method and apparatus according to embodiments. In more detail, (a) of FIG. 3 illustrates a specimen positioned in a horizontal direction, and (b) of FIG. 3 is a diagram illustrating a specimen positioned in a vertical direction.

The specimen 10 illustrated in FIG. 3 may correspond to the specimen 10 illustrated in FIGS. 1 and 2.

A cross section of the specimen 10 illustrated in FIG. 3 corresponds to a rectangle, but this is only an example, and the cross section of the specimen 10 may have any shape, such as a circle or a polygon. However, for convenience of explanation, it is assumed that a cross section of the specimen 10 is rectangular.

As shown in FIG. 3, the specimen 10 may include a conductive material 11 and an insulating material 13 with which a surface of the conductive material 11 is coated. In this case, the conductive material 11 may include copper, and the insulating material 13 may include enamel. That is, the specimen 10 may include an enamel wire (enamel copper wire) in which a resin film including enamel as an insulating material is formed on a surface of a copper wire, which is a conductor material.

The length and width of the specimen 10 may vary depending on the position. For example, as shown in (a) of FIG. 3, when a first surface 13a of the specimen 10 is positioned in a horizontal state corresponding to an upper surface, a horizontal length (or length) of the specimen 10 may be b1, and a vertical length (or height) may be d1. For example, as shown in (b) of FIG. 3, when a second surface 13b of the specimen 10 is positioned in a vertical state corresponding to an upper surface, a horizontal length (or length) of the specimen 10 may be b2, and a vertical length (or height) may be d2.

In this case, when the cross section of the specimen 10 is rectangular as in the example illustrated in FIG. 3, the horizontal length b1 (refer to (a) of FIG. 3) of the specimen 10 positioned in a horizontal state may be the same as the vertical length d2 (refer to (b) of FIG. 3) of the specimen 10 positioned in a vertical state.

The specimen 10 may have a bar shape having a length in a certain direction. In this case, a length L of the specimen 10 may be about 40 cm.

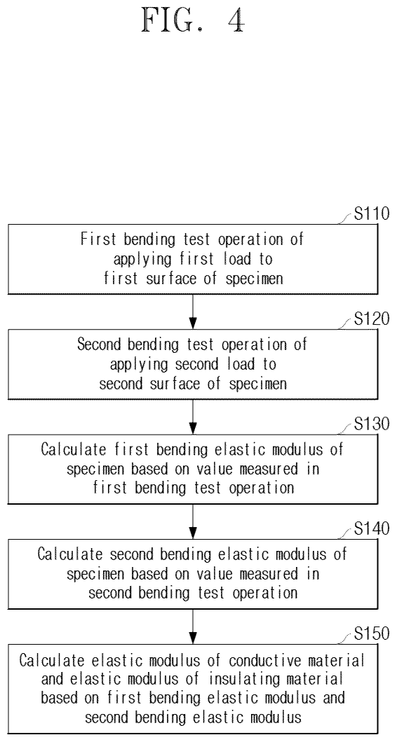

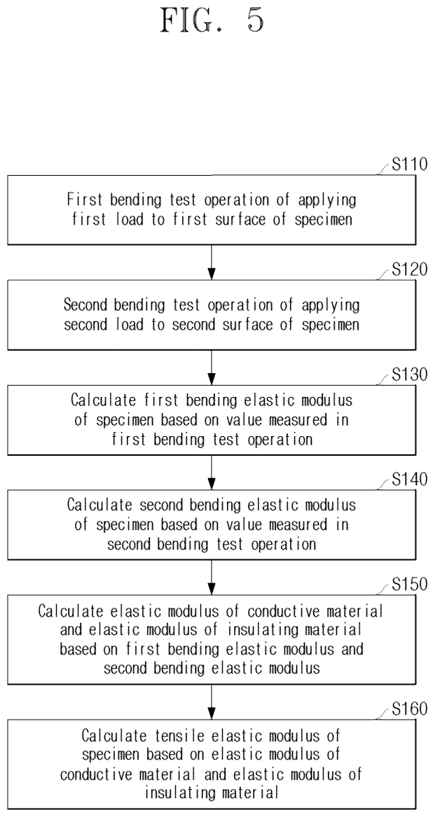

FIG. 4 is a flowchart illustrating a method for measuring an elastic modulus according to embodiments. FIG. 5 is a flowchart illustrating a method for measuring an elastic modulus according to embodiments. FIG. 6 is a diagram to explain a method for measuring a bending elastic modulus of an elastic modulus measuring method and apparatus according to embodiments.

FIG. 4 and FIG. 5 illustrate a method of measuring the elastic modulus of the specimen 10 by using the elastic modulus measuring apparatus 100 illustrated in FIG. 1 and FIG. 2.

Referring to FIG. 4, the elastic modulus measuring method according to the embodiments may include a first bending test operation S110 of applying a first load to the first surface 13a (refer to (a) of FIG. 3) of the specimen 10, a second bending test operation S120 of applying a second load to the second surface 13b (refer to (b) of FIG. 3) of the specimen 10, a first calculation operation S130 of calculating a first bending elastic modulus of the specimen 10 based on the value measured in operation S110, a second calculation operation S140 of calculating a second bending elastic modulus of the specimen 10 based on the value measured in operation S120, and a third calculation operation S150 of calculating an elastic modulus of the conductive material 11 and an elastic modulus of the insulating material 13 constituting the specimen 10 based on the first bending elastic modulus calculated in operation S130 and the second bending elastic modulus calculated in operation S140, respectively.

The first bending test operation S110 includes an operation of positioning the specimen 10 such that the first surface 13a corresponds to the upper surface and applying the first load to the first surface 13a, as shown in (a) of FIG. 3. The second bending test operation S120 includes an operation of positioning the specimen 10 such that the second surface 13b corresponds to the upper surface and applying the second load to the second surface 13b, as shown in (a) of FIG. 3. In this case, the first load and the second load may have the same size or different sizes.

For convenience of explanation, it is explained that the second bending test operation S120 is performed after the first bending test operation S110, but a time order of the first bending test operation S110 and the second bending test operation S120 may not matter. For example, according to embodiments, the second bending test operation S120 may be performed before the first bending test operation S110, or according to embodiments, the first bending test operation S110 and the second bending test operation S120 may be performed simultaneously.

Similar to the first calculation operation S130 of calculating the first bending elastic modulus of the specimen 10 based on the value measured in the first bending test operation S110, an operation of calculating the second bending elastic modulus of the specimen 10 based on the value measured in the second bending test operation S120 may include calculating the first bending elastic modulus and the second bending elastic modulus based on Equation 1.

$${E}_{B} = 0.21 \frac{{PL}^{3}}{{δ}_{c} {bd}^{3}} \qquad [ Equation 1 ]$$

Here, E_{B} is the first bending elastic modulus or the second bending elastic modulus, P is the first load or the second load, L is a length between the supports 110, δ_{c} is an amount of deflection of the specimen 10, b is a width of the specimen, and d is a height of the specimen. In this case, L is a length between the supports 110, but the supports 110 may be a length of the specimen 10 as the supports 110 support both ends of the specimen 10.

Referring to FIG. 6 together, δ_{c} may be the amount of deflection in a central portion of the specimen 10. The amount of deflection may correspond to a length of a deflection degree.

That is, the first bending test operation S110 may include measuring a value of the first load applied to the first surface 13a of the specimen 10, a value of a length L between the supports 110 supporting both ends of the specimen 10, the amount of deflection (δ_{c}) of the specimen 10 caused by the first load, a value of the width b of the specimen 10 (b1, refer to (a) of FIG. 3), and a value of the height d of the specimen 10 (d1, refer to (a) of FIG. 3), and the first calculation operation S130 may include measuring the first bending elastic modulus according to Equation 1 based on the measured values.

Similarly, the second bending test operation S120 may include measuring a value of the second load applied to the second surface 13b of the specimen 10, a value of the length L between the supports 110 supporting both ends of the specimen 10, the amount of deflection (δ_{c}) of the specimen 10 caused by the second load, a value of the width b of the specimen 10 (b2, refer to (b) of FIG. 3), and a value of the height d of the specimen 10 (d2, refer to (b) of FIG. 3), and the second calculation operation S140 may include measuring the second bending elastic modulus according to Equation 1 based on the measured values.

Therefore, the first bending elastic modulus and the second bending elastic modulus may have different values.

In this case, both the first bending elastic modulus and the second bending elastic modulus calculated in operations S130 and S140 respectively correspond to the bending elastic modulus of the specimen 10. In other words, the first bending elastic modulus and the second bending elastic modulus correspond to the bending elastic modulus of the specimen 10, which is a type of composite including the conductive material 11 and the insulating material 13.

Therefore, the elastic modulus measuring method according to embodiments may include calculating the elastic modulus of the conductive material 11 and the elastic modulus of the insulating material 13 constituting the specimen 10 based on the first bending elastic modulus and the second bending elastic modulus, which are the bending elastic moduli of the specimen 10, respectively, in the third calculation operation S150. That is, as described with reference to FIG. 3, the elastic modulus measuring method according to embodiments may include measuring the elastic modulus of copper constituting an enamel wire (enamel copper wire) and the elastic modulus of enamel.

In more detail, the third calculation operation S150 may include calculating the elastic modulus of the conductive material 11 and the elastic modulus of the insulating material 13 based on Equation 2 below.

$${E}_{C} = ( \frac{{E}_{B , 1} {I}_{1}}{{I}_{E , 1}} - \frac{{E}_{B , 2} {I}_{2}}{{I}_{E , 2}} ) / ( \frac{{I}_{C , 1}}{{I}_{E , 1}} - \frac{{I}_{C , 2}}{{I}_{E , 2}} ) \qquad [ Equation 2 ]$$

$${E}_{E} = ( \frac{{E}_{B , 1} {I}_{1}}{{I}_{C , 1}} - \frac{{E}_{B , 2} {I}_{2}}{{I}_{C , 2}} ) / ( \frac{{I}_{E , 1}}{{I}_{C , 1}} - \frac{{I}_{E , 2}}{{I}_{C , 2}} )$$

Here, E_{C} is the elastic modulus of the conductive material 11, E_{E} is the elastic modulus of the insulating material 13, E_{B,1} is the first bending elastic modulus calculated in operation S130, E_{B,2} is the second bending elastic modulus calculated in operation S140, I₁ is a geometrical moment of inertia of the specimen 10 in operation S110, I₂ is the geometrical moment of inertia of the specimen 10 in operation S120, I_{C,1} is a geometrical moment of inertia of the conductive material 11 in operation S110, I_{C,2} is a geometrical moment of inertia of the conductive material 11 in operation S120, I_{E,1} is a geometrical moment of inertia of the insulating material 13 in operation S110, and I_{E,2} is a geometrical moment of inertia of the insulating material 13 in operation S120.

Equation 2 above may be calculated by combining Equation 3 below and Equation 4 below.

$${E}_{B , 1} {I}_{1} = {E}_{C} {I}_{C , 1} + {E}_{E} {I}_{E , 1} \qquad [ Equation 3 ]$$

$${E}_{B , 2} {I}_{2} = {E}_{C} {I}_{C , 2} + {E}_{E} {I}_{E , 2} \qquad [ Equation 4 ]$$

The geometrical moment of inertia of the specimen 10, the geometrical moment of inertia of the conductive material 11, and the geometrical moment of inertia of the insulating material 13 may be obtained using a geometrical moment of inertia formula.

For example, referring to FIG. 3, in the case of the specimen 10 having a rectangular cross-section, the geometrical moment of inertia of the specimen 10 may be calculated according to Equation 5 below.

$$I = \frac{1}{12} {bd}^{3} \qquad [ Equation 5 ]$$

The geometrical moment of inertia of the conductive material 11 and the geometrical moment of inertia of the insulating material 13 constituting the specimen 10 may be calculated according to Equations 6 and 7, respectively.

$${I}_{c} = \frac{1}{12} ( b - 2 t ) {( d - 2 t )}^{3} \qquad [ Equation 6 ]$$

$${I}_{E} = I - {I}_{c} \qquad [ Equation 7 ]$$

That is, the first bending elastic modulus and the second bending elastic modulus of the specimen 10 may be calculated in the first calculation operation S130 and the second calculation operation S140, respectively, and the geometrical moment of inertia of the specimen 10 in the first bending test operation S110 and the geometrical moment of inertia of the specimen 10 in the second bending test operation S120 may be calculated using Equation 5 above. The geometrical moment of inertia of the conductive material 11 and the geometrical moment of inertia of the insulating material 13 in the first bending test operation S110 and the geometrical moment of inertia of the conductive material 11 and the geometrical moment of inertia of the insulating material 13 in the second bending test operation S120 may also be calculated using Equations 6 and 7 above, respectively.

Accordingly, the third calculation operation S150 may include calculating the elastic modulus of the conductive material 11 and the elastic modulus of the insulating material 13 based on Equation 2 above.

As a result, the third calculation operation S150 may include obtaining the elastic modulus of the conductive material 11 and the elastic modulus of the insulating material 13 constituting the specimen 10 by using the first bending elastic modulus calculated in operation S130 and the second bending elastic modulus calculated in operation S140, respectively.

Therefore, the elastic modulus measuring method according to embodiments may include calculating elastic moduli of the conductive material 11 and the insulating material 13 constituting the specimen 10 based on the bending elastic modulus of the specimen 10 as a composite.

As illustrated in FIG. 5, the elastic modulus measuring method according to embodiments may further include a fourth calculation operation S160 of calculating the tensile elastic modulus of the specimen 10 based on the elastic modulus of the conductive material 11 and the elastic modulus of the insulating material 13 calculated in operation S150.

That is, the elastic modulus measuring method according to embodiments may have an effect of calculating the tensile elastic modulus of the specimen 10 as a result by using a bending test.

In more detail, the fourth calculation operation may include calculating the tensile elastic modulus of the specimen 10 according to Equation 8 below.

$${E}_{T} A = {E}_{C} {A}_{C} + {E}_{E} {A}_{E} \qquad [ Equation 8 ]$$

Here, E_{T} is the tensile elastic modulus of the specimen 10, E_{C} is the elastic modulus of the conductive material 11, E_{E} is the elastic modulus of the insulating material 13, A is a cross-sectional area of the specimen 10, A_{C} is a cross-sectional area of the conductive material 11, and A_{E} is a cross-sectional area of the insulating material 13.

That is, the elastic modulus of the conductive material 11 and the elastic modulus of the insulating material 13 may be calculated in the third calculation operation S150, and the cross-sectional area of the specimen 10, the cross-sectional area of the conductive material 11, and the cross-sectional area of the insulating material 13 may be measured by analyzing a shape dimensions of the specimen 10.

Thus, the fourth calculation operation S160 may include calculating the tensile elastic modulus of the specimen 10 according to Equation 8 below.

As a result, the fourth calculation operation S160 may include obtaining the tensile elastic modulus of the specimen 10 by using the elastic modulus of the unique conductive material 11 and the elastic modulus of the unique insulating material 13 calculated in operation S150.

Therefore, the elastic modulus measuring method according to embodiments has an effect of measuring the tensile elastic modulus of the specimen 10 only through a bending test, not a tensile test.

FIG. 7 is a diagram to explain a speed of a load applied to a specimen of a method and apparatus for measuring an elastic modulus according to embodiments.

Referring to FIG. 7, a load P applied by the pressurizer 120 of the elastic modulus measuring apparatus 100 according to embodiments or the first load or the second load applied in the first bending test operation S110 and the second bending test operation S120 of the elastic modulus measuring method according to embodiments may be applied at a specific speed V.

In this case, the specific speed of the load P applied to the specimen 10 may satisfy Equation 9 below.

$$V = 0.185 \frac{\dot{ε} {L}^{2}}{d} \qquad [ Equation 9 ]$$

Here, V is a speed of applying a load, ¿ is a speed of a strain at the lowest portion of the specimen 10, L is a length between the supports 110 supporting both lower or lateral portions of the specimen 10, and d is a height of the specimen 10.

In this case, to measure a stable bending elastic modulus, \dot{ε} may have a value of 0.001 or less.

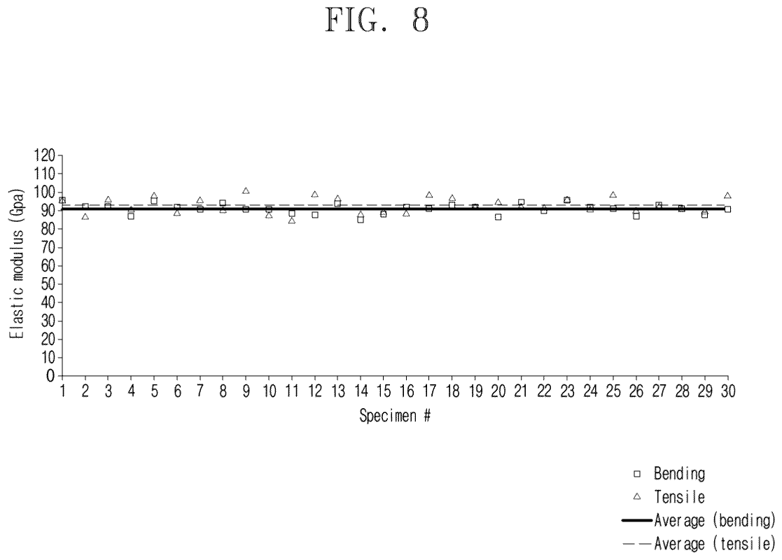

FIG. 8 is a table showing values of a bending elastic modulus and a tensile elastic modulus calculated by a method and apparatus for measuring an elastic modulus according to the embodiments.

As shown in FIG. 8, the bending elastic modulus and the tensile elastic modulus of the specimen 10 may be calculated according to the elastic modulus measuring apparatus 100 according to embodiments or the elastic modulus measuring method according to embodiments.

According to embodiments, there is an effect of measuring accurate elastic properties of each material by providing an apparatus/method for measuring the elastic modulus of each material constituting the composite material.

According to embodiments, there is an effect of measuring the tensile elastic modulus in a short period of time by providing an apparatus/method for measuring not only the bending elastic modulus but also the tensile elastic modulus through a bending test.

The effects that are achievable by the present disclosure are not limited to what has been particularly described hereinabove and other advantages not described herein will be more clearly understood by persons skilled in the art from the following description.

As described above, the detailed description of the embodiments of the present disclosure has been given to enable those skilled in the art to implement and practice the disclosure. Although the disclosure has been described with reference to the embodiments, those skilled in the art will appreciate that various modifications and variations may be made in the present disclosure without departing from the spirit or scope of the disclosure and the appended claims. For example, those skilled in the art may use constructions disclosed in the above-described embodiments in combination with each other.

Therefore, the present disclosure intends not to limit the embodiments disclosed herein but to give a broadest range matching the principles and new features disclosed herein.

What is claimed is:

1. A method of measuring an elastic modulus of a specimen including a conductive material and an insulating material with which a surface of the conductive material is coated, the method comprising:
a first bending test operation of applying a first load to a first surface of the specimen;
a second bending test operation of applying a second load to a second surface that meets the first surface of the specimen;
a first calculation operation of calculating a first bending elastic modulus of the specimen based on a first value measured in the first bending test operation;
a second calculation operation of calculating a second bending elastic modulus of the specimen based on a second value measured in the second bending test operation; and
a third calculation operation of calculating an elastic modulus of the conductive material and an elastic modulus of the insulating material based on the calculated first bending elastic modulus and the calculated second bending elastic modulus.

2. The method of claim 1, wherein the first bending test operation and the second bending test operation are performed in an elastic region of the specimen.

3. The method of claim 1, wherein the first bending test operation and the second bending test operation are performed through a four-point bending test with two application points in which the first load is applied to the first surface and two application points in which the second load is applied to the second surface.

4. The method of claim 3, wherein a cross section of the specimen is rectangular, and
the first calculation operation and the second calculation operation include calculating the first bending elastic modulus and the second bending elastic modulus based on a following equation, respectively,
$${E}_{B} = 0.21 \frac{{PL}^{3}}{{δ}_{c} {bd}^{3}} \qquad Equation$$
where E_{B} is the first bending elastic modulus or the second bending elastic modulus, P is the first load or the second load, L is a length between supports supporting both lower portions or lateral portions of the specimen, δ_{c} is a measured center displacement of the specimen, b is a width of the specimen, and d is a height of the specimen.

5. The method of claim 1, wherein the third calculation operation includes calculating a bending elastic modulus of the conductive material and an elastic modulus of the insulating material based on a following equation,
$${E}_{C} = ( \frac{{E}_{B , 1} {I}_{1}}{{I}_{E , 1}} - \frac{{E}_{B , 2} {I}_{2}}{{I}_{E , 2}} ) / ( \frac{{I}_{C , 1}}{{I}_{E , 1}} - \frac{{I}_{C , 2}}{{I}_{E , 2}} ) \qquad Equation$$
$${E}_{E} = ( \frac{{E}_{B , 1} {I}_{1}}{{I}_{C , 1}} - \frac{{E}_{B , 2} {I}_{2}}{{I}_{C , 2}} ) / ( \frac{{I}_{E , 1}}{{I}_{C , 1}} - \frac{{I}_{E , 2}}{{I}_{C , 2}} )$$
where E_{C} is an elastic modulus of the conductive material, E_{E} is an elastic modulus of the insulating material, E_{B,1} is the first bending elastic modulus, E_{B,2} is the second bending elastic modulus, I₁ is a geometrical moment of inertia of the specimen in the first bending test operation, I₂ is a geometrical moment of inertia of the specimen in the second bending test operation, I_{C,1} is a geometrical moment of inertia of the conductive material in the first bending test operation, I_{C,2} is a geometrical moment of inertia of the conductive material in the second bending test operation, I_{E,1} is a geometrical moment of inertia of the insulating material in the first bending test operation, and I_{E,2} is a geometrical moment of inertia of the insulating material in the second bending test operation.

6. The method of claim 1, further comprising a fourth calculation operation of calculating a tensile elastic modulus of the specimen based on a calculated elastic modulus of the conductive material and a calculated elastic modulus of the insulating material.

7. The method of claim 6, wherein the fourth calculation operation includes calculating a tensile elastic modulus of the specimen based on a following equation,
$${E}_{T} A = {E}_{C} {A}_{C} + {E}_{E} {A}_{E} \qquad Equation$$
where E_{T} is the tensile elastic modulus, E_{C} is an elastic modulus of the conductive material, E_{E} is an elastic modulus of the insulating material, A is a cross section of the specimen, A_{C} is a cross section of the conductive material, and A_{E} is a cross section of the insulating material.

8. The method of claim 1, wherein the first bending test operation and the second bending test operation include applying the first load and the second load to the specimen at a specific speed, respectively, wherein the specific speed satisfies a following equation,
$$V = 0.185 \frac{\dot{ε} {L}^{2}}{d} \qquad Equation$$
where V is a speed at which the first load or the second load is applied, \dot{ε} is a speed of a strain at a lowest portion of the specimen, L is a length between supports supporting both portions or lateral portions of the specimen, and d is a height of the specimen.

9. An apparatus for measuring an elastic modulus, the apparatus comprising:
a pair of supports supporting at least one of a lower surface of two ends of a specimen or a lateral portion of the two ends;
a pressurizer configured to apply a load to an upper surface of the specimen; and
a sensor configured to measure a displacement by which the specimen is deformed by the load,
wherein the specimen includes:
a conductive material; and
an insulating material with which a surface of the conductive material is coated, and
the apparatus includes a four-point bending test apparatus with two application points in which the road is applied to the upper surface of the specimen.

10. The apparatus of claim 9, wherein the pressurizer applies the load to the upper surface of the specimen at a specific speed, and the specific speed satisfies a following equation,
$$V = 0.185 \frac{\dot{ε} {L}^{2}}{d} \qquad Equation$$
where V is a speed at which the load is applied, \dot{ε} is a speed of a strain at a lowest portion of the specimen, L is a length between the pair of supports, and d is a height of the specimen.
